(19) United States
(12) Patent Application Publication
(10) Pub. No.: US 2017/0344297 A1
(43) Pub. Date: Nov. 30, 2017

(54) MEMORY ATTRIBUTION AND CONTROL

(71) Applicant: Microsoft Technology Licensing, LLC, Redmond, WA (US)

(72) Inventors: Matthew John Woolman, Seattle, WA (US); Mehmet lyigun, Kirkland, WA (US)

(21) Appl. No.: 15/165,268

(22) Filed: May 26, 2016

(51) Int. Cl. G06F 3/06

(52) U.S. Cl. CPC G06F 3/0631; G06F 3/0685; G06F 3/0604; G06F 3/067

(57) ABSTRACT

A computing system includes one or more processors and a system memory that stores computer executable instructions that can be executed by the processors. The system accesses from one or more memory requests a unique identifier. The unique identifier identifies a system entity that requests an allocation of memory resources. The system maps the unique identifier to a specific memory resource allocation. This specific memory resource allocation is attributable to the system entity. The specific memory resource allocation is associated with one or more memory policies that specify in what manner the specific memory resource allocation is to be allocated to the system entity. The system causes the allocation of the specific memory resource allocation to the system entity based on the one or more memory policies.

### BACKGROUND

Processes often do work on behalf of several components. However, most components allocate memory from a shared memory resource. Use of this shared memory resource may make it difficult for the system to differentiate between the memory allocated to one component and the memory allocated to a different component. This inability to attribute the memory allocation to a given component makes it difficult for the system to place limits on the resources used by the components, even when placing such limitations might be beneficial to the operation of the system.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments disclosed herein are related to systems and methods for attribution of memory resources allocated to a system entity. In one embodiment, a computing system includes one or more processors and a system memory that stores computer executable instructions that can be executed by the processors to cause the computing system to perform the following. The system accesses from one or more memory requests a unique identifier. The unique identifier identifies a system entity that requests an allocation of memory resources. The system maps the unique identifier to a specific memory resource allocation. This specific memory resource allocation is attributable to the system entity. The specific memory resource allocation is associated with one or more memory policies that specify in what manner the specific memory resource allocation is to be allocated to the system entity. The system causes the allocation of the specific memory resource allocation to the system entity based on the one or more memory policies.

In another embodiment, a computing system includes one or more processors and a system memory that stores computer executable instructions that can be executed by the processors to cause the computing system to perform the following. The system receives one or more memory requests from a system entity requesting an allocation of memory from a shared memory resource that is shared by a plurality of system entities. The system accesses from the one or more memory requests a unique identifier. The unique identifier identifies the system entity that requests the allocation of memory resources from the shared memory resource. The system maps the unique identifier to a private memory portion of the shared memory resource. The system automatically redirects the allocation of memory for the system entity to the private memory portion without informing the system entity that the allocation of memory has been redirected. Accordingly, from the perspective of the system entity, the allocation of memory is from the shared memory resource.

Additional features and advantages will be set forth in the description, which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates an embodiment of a computing system able to perform memory attribution and control according to the embodiments disclosed herein;

FIGS. 3A-3C illustrate an embodiment of a table for mapping a memory allocation to a system entity unique identifier;

FIG. 4 illustrates an alternative embodiment of a table for mapping a memory allocation to a system entity unique identifier;

FIG. 5 illustrates a flow chart of an example method for attribution of memory resources allocated to a system entity; and

FIG. 6 illustrates a flow chart of an alternative example method for attribution of memory resources allocated to a system entity.

### DETAILED DESCRIPTION

Aspects of the disclosed embodiments relate to systems and methods for attribution of memory resources allocated to a system entity. The system accesses from one or more memory requests a unique identifier. The unique identifier identifies a system entity that requests an allocation of memory resources. The system maps the unique identifier to a specific memory resource allocation. This specific memory resource allocation is attributable to the system entity. The specific memory resource allocation is associated with one or more memory policies that specify in what manner the specific memory resource allocation is to be allocated to the system entity. The system causes the allocation of the specific memory resource allocation to the system entity based on the one or more memory policies.

In another aspect, the system receives one or more memory requests from a system entity requesting an allocation of memory from a shared memory resource that is shared by a plurality of system entities. The system accesses from the one or more memory requests a unique identifier. The unique identifier identifies the system entity that requests the allocation of memory resources from the shared memory resource. The system maps the unique identifier to a private memory portion of the shared memory resource. The system automatically redirects the allocation of memory for the system entity to the private memory portion without informing the system entity that the allocation of memory has been redirected. Accordingly, from the perspective of the system entity, the allocation of memory is from the shared memory resource.

There are various technical effects and benefits that can be achieved by implementing the aspects of the disclosed embodiments. By way of example, it is now possible to accurately attribute a memory allocation to a system entity. In addition, it is also now possible to use policies to limit or otherwise control the memory allocation. Further, the technical effects related to the disclosed embodiments can also include improved user convenience and efficiency gains.

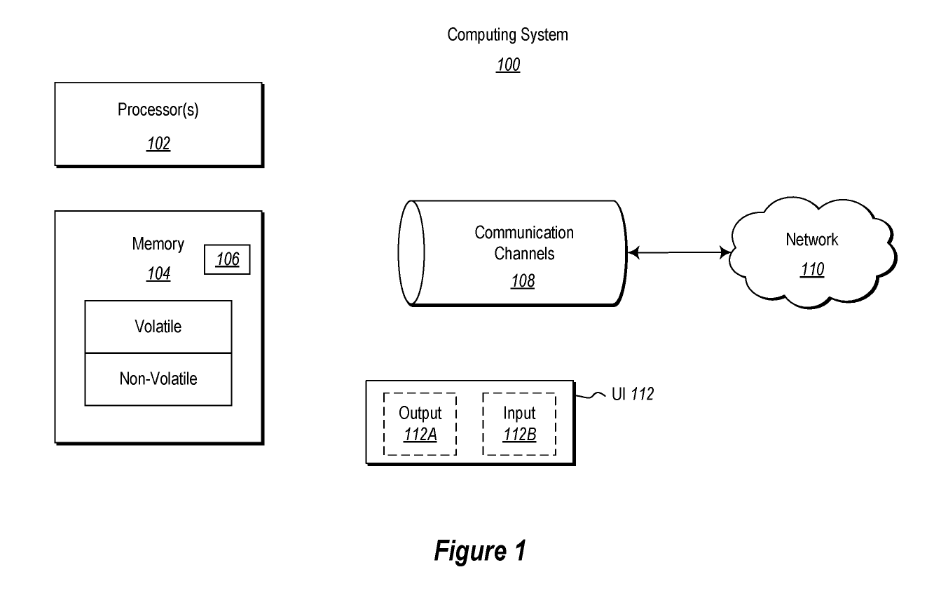

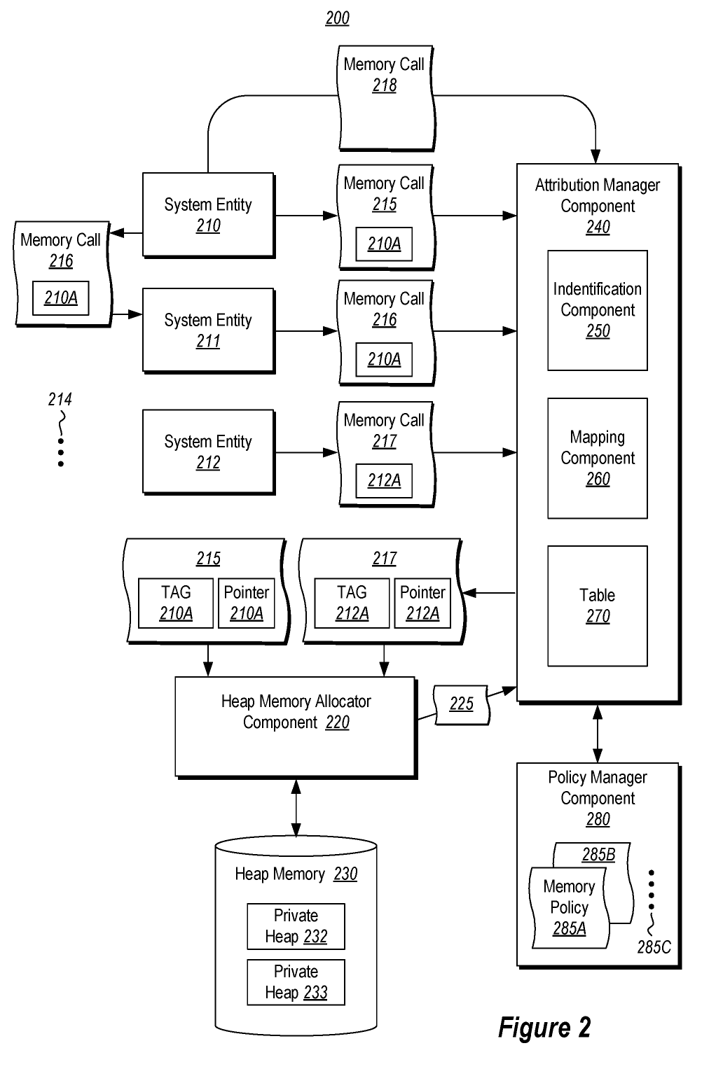

Some introductory discussion of a computing system will be described with respect to FIG. 1. Then, the system for attribution of memory resources allocated to a system entity will be described with respect to FIG. 2 through FIG. 6.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 100 also has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface system 112 for use in interfacing with a user. The user interface system 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Attention is now given to FIG. 2, which illustrates an embodiment of a computing system 200, which may correspond to the computing system 100 previously described. The computing system 200 includes various components or functional blocks that may implement the various embodiments disclosed herein as will be explained. The various components or functional blocks of the computing system 200 may be implemented on a local computing system or may be implemented on a distributed computing system that includes elements resident in the cloud or that implement aspects of cloud computing. The various components or functional blocks of the computing system 200 may be implemented as software, hardware, or a combination of software and hardware. The computing system 200 may include more or less than the components illustrated in FIG. 2 and some of the components may be combined as circumstances warrant. Although not necessarily illustrated, the various components of the computing system 200 may access and/or utilize a processor and memory, such as processor 102 and memory 104, as needed to perform their various functions.

As illustrated in FIG. 2, the computing system 200 includes a system entity 210, a system entity 211, and a system entity 212, although it will noted that there may be any number of additional system entities as illustrated by ellipses 214. The system entities 210-214 may be entities that are implemented by or executed by, for example, an operating system of the system 200. The system entities 210-214 may be one or more jobs, one or more processes, or one or more threads associated with a process or a job. The system entities 210-214 may also be a system component such as a program that is executing on the computing system 200. The system entities 210-214 may generate various activities or tasks that help the system entities perform their intended functionality. The various activities or tasks may include jobs, processes, threads, or the like that perform the functionality of the activity or task. Thus, the system entities 210-214 may have multiple activities or tasks executing at the same time as circumstances warrant. Each of these activities may use any number of processes as needed. Thus, it may be common for the work of the activity to pass threads between the multiple processes. In addition, it may be common for a process or thread to do work on behalf of more than one component. Accordingly, “system entity” is to be interpreted broadly and the embodiments disclosed herein are not limited by a specific type or implementation of the system entities 210-214.

In some embodiments, a system entity such as system entity 210 may make a heap memory call 215 to a heap memory allocator component 220 requesting an allocation of heap memory resources. The heap memory allocator component 220 may then allocate some portion of a shared or general heap memory 230 for the use of the system entity 210, which will typically be the amount of heap memory requested in the heap memory call 215. The system entities 211 and 212 may also make heap memory calls to the heap memory allocator component 220 in similar fashion. While this may allow for the allocation of sufficient heap memory resources for each system entity, the computing system does not typically have any way to distinguish the heap memory allocations between different system entities since all the system entities are sharing the same shared heap memory 230.

In other embodiments, a system entity may be able to make use of other system entities to perform its intended functionality. Accordingly, it may be those other system entities that make the heap memory call to the heap memory allocator component 220. For example, as illustrated in FIG. 2, the system entity 210 may use the system entity 211 to perform some of its functionality. This may be accomplished by the system entity 210 passing a thread, process, or the like to the system entity 211. The system entity 211 may then make a heap memory call 216 on behalf of the system entity 210 so that the system entity 210 can perform its intended functionality. Thus, although it is the system entity 211 that makes the heap memory call 216, it is the system entity 210 that ultimately initiated the heap memory call since the system entity 211 makes the heap memory call 216 on behalf of the system entity 210.

In such embodiments where the system entity 210 is able to make use of system entity 211 to perform its intended functionality, the computing system 200 may not have any way to attribute the heap memory allocation requested by the heap memory call 216 to the system entity 210, which initiated the heap memory call 216 as described above. This may prevent the computing system 200 from imposing limits on the amount of heap memory resources allocated to the system entity 210. For example, the system entity 210 may only be entitled to a maximum amount of the heap memory 230 due to some policy or the like that imposes limits or constraints on the amount of heap memory 230 that may be allocated to the system entity 210. However, if the computing system 200 is unable to attribute the heap memory call 216 to the system entity 210 since it ultimately initiated the heap memory call 216, then it is possible that by using the system entity 211 to make a heap memory call in its behalf, the system entity 210 may be able to bypass any policies that impose the heap memory resource limitations or constraints. Thus, the heap memory allocator component 220 may allocate more of the heap memory 230 than the system entity 210 is entitled to.

Advantageously, the computing system 200 may include an attribution manager component 240 (hereinafter referred to as “attribution manger 240”). In operation, heap memory calls such as heap memory calls 215, 216, and 217 may be redirected to the attribution manager 240 prior to being sent to the heap memory allocator component 220. The attribution manager 240 is configured to determine the amount of heap memory 230 resources that are attributable to a given system entity, such as the system entities 210, 211, and 212. The attribution manager 240 may include various components that perform these tasks such as an identification component 250 and a mapping component 260. It will be noted that although the attribution manager 240 is illustrated as a single component, this is for ease of explanation only. Accordingly, the attribution manager 240 and its various components may be any number of separate components that function together to constitute the attribution manager 240.

As mentioned, the attribution manager 240 includes an identification component or module 250. In operation, the identification component 250 receives the heap memory calls from the various system entities. For example, the identification module 250 may receive heap memory call 215 from system entity 210, heap memory call 216 from the system entity 211 on behalf of the system entity 210, and heap memory call 217 from system entity 212. Although not illustrated, the identification component 250 may receive any number of additional heap memory calls from the additional system entities 214.

When one of the heap memory calls 215, 216, and/or 217 is received, the identification component 250 may access or otherwise determine a unique identifier that is attached to the heap memory call and that identifies the system entity that initiates the heap memory call. The unique identifier may be generated by the computing system 200 and may include information such as metadata that identifies the system entity that was the ultimate initiator of the heap memory call.

As previously discussed, the system entity 210 directly initiates the heap memory call 215. Accordingly, the computing system 200 may mark the heap memory call 215 with a unique identifier 210A that associates the heap memory call with the system entity 210. In addition, because the system entity 210 uses the system entity 211 to make the heap memory call 216 on its behalf, the heap memory call 216 inherits the unique identity 210A from the thread or like that was handed off to the system entity 211 from the system entity 210. Accordingly, the heap memory call 216 is also marked with the unique identifier 210A, which marks the heap memory call 216 as being associated with the system entity 210.

On the other hand, the heap memory call 217 is initiated by the system entity 212, either directly or after being passed off to one or more other system entities. Accordingly, the heap memory call 217 is marked with a unique identifier 212A that associates the heap memory call with the system entity 212.

Once the identification component 250 has determined or accessed the unique identifier for the heap memory call 215, the heap memory call 216, and/or the heap memory call 217, the identification component 250 may access a table 270 that is stored by the attribution manager 240 to determine if the system entity that imitated the heap memory call has been seen before by the attribution manager 240. If the system entity that initiated the heap memory call has initiated a heap memory call previously, then its unique identifier may already be listed in the table 270. However, if the system entity that initiated the heap memory call has not previously initiated a heap memory call, its unique identifier may not listed in the table 270 an the identification module 250 may populate an entry in the table 270 with the unique identifier of that system entity.

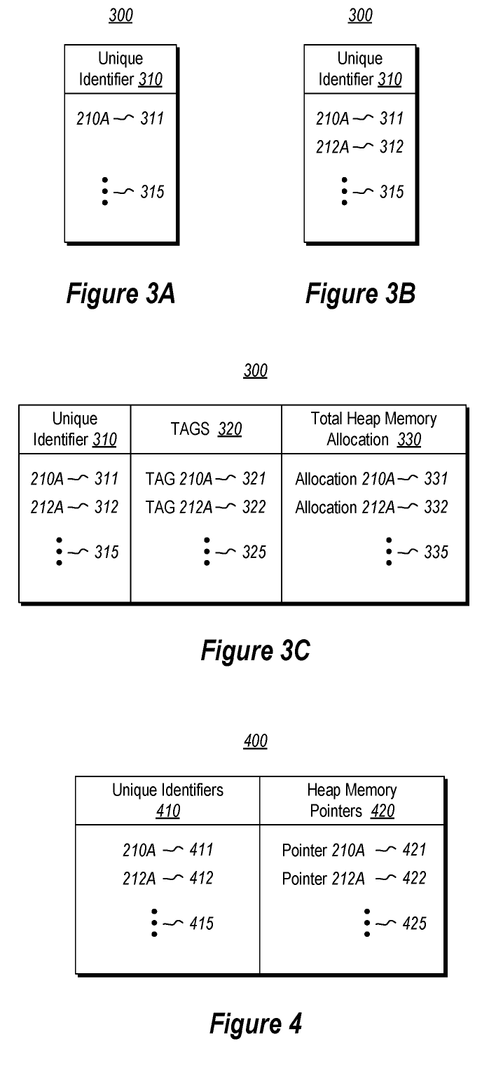

Turning to FIG. 3A, an embodiment of a portion of a table 300, which may be an example embodiment of the table 270, is illustrated. As shown, the table 300 includes unique identifiers 310, which is where the unique identifiers for the system entities are listed. As denoted at 311, the table 300 lists the unique identifier 210A, which is associated with the system entity 210. Accordingly, when the identification component 250 accesses the table 300, it may determine that that system entity 210 has been seen before. In other words, the system entity 210 has initiated at least one previous heap memory call such as the heap memory calls 215 and 216 that has previously been seen by the attribution manager 240. It will be noted that the ellipses 315 represents that the unique identifiers 310 may include any number of additional entries if other system entities have already been seen by the attribution manager 240.

The unique identifiers 310 in FIG. 3A, however, do not include the unique identifier 212A associated with system entity 212. Accordingly, the identification component 250 may determine that the system entity 212 has not initiated any previous heap memory calls and has therefore not been seen before by the attribution manager 240. According, as shown in FIG. 3B, which illustrates a portion of the table 300, as denoted at 312 the identification module 250 may populate the table 300 with unique identifier 212A.

Returning to FIG. 2, once the identification module 250 has either determined that the unique identifier for a system entity is in the table 270 or has added the unique identifier to the table, the mapping component 260 may map the unique identifier to a specific heap memory 230 resource allocation as will now be explained. In one embodiment, the mapping component 260 may associate the unique identifiers for each of the system entities with a tag in the table 270. The tag may mark the specific allocation of the heap memory 230 for each of the system entities and allow the amount of heap memory 230 allocated to the system entities to be tracked.

Turning to FIG. 3C, a further view of the table 300 is illustrated. As shown, the table 300 includes tags 320 that are associated with the unique identifiers 310. For example, the tags 320 may include a tag 210A denoted at 321 that is associated with the unique identifier 210A and a tag 212A denoted at 322 that is associated with the unique identifier 212A. It will be noted that ellipses 325 illustrate that there may be any number of additional tags 320 that are associated with the unique identifiers 215.

Once the tags 320 have been associated with the unique identifiers 310, the attribution manager 240 may pass the heap memory calls 215, 216, and/or 217 to the heap memory allocator component 220. For example, FIG. 2 illustrates the memory call 215 including the tag 210A (321) and the memory call 217 including the tag 212A (322) being passed to the heap memory allocator component 220. Although not illustrated, the heap memory call 216 including the tag 210A (321) may also be passed to the heap memory allocator component 220. The heap memory allocator component 220 may then allocate the heap memory requested in the heap memory calls 215 and 216 to the system entity 210 and may allocate the heap memory requested in the heap memory call 217 to the system entity 212. This memory allocation may the provided to the system entities for their use.

In one embodiment, the heap memory allocator component 220 may also report back to the mapping component 260 the total heap memory allocation that is attributable to each system entity based on the tags 320 as shown at 225. For example, since the heap memory calls 215 and 216 were both ultimately initiated by the system entity 210 and thus are attributable to the system entity 210, the total heap memory allocation for both heap memory calls would be associated with the tag 210A (321) and this total heap memory allocation would be reported to the mapping component 260. Likewise, the total memory heap allocation requested by the heap memory call 217 that is associated with the tag 212A (322) would also be reported to the mapping component 260.

In another embodiment, the mapping component 260 tracks the total heap memory allocation that is associated with each of the tags 320 based on the success or failure of the heap memory calls that it has made on behalf of a system entity. For example, if one or both of the heap memory calls 215 and 216 were successful, then the mapping component 260 would track the heap memory allocation that was associated with the tag 210A (321) based on the success of the heap memory call. Likewise, if the heap memory call 217 were successful, then the mapping component 260 would track the heap memory allocation associated with the tag 212A (322) based on the success of the heap memory call. Of course, a failed heap memory call 215, 216, and/or 217 would not result in an allocation of heap memory resources and so would not be included in the total heap memory allocation associated with the tags 320.

The mapping component 260 may then record in the table 270 the total heap memory allocation associated with each of the tags 320. For example, as shown in FIG. 3C, the table 300 may include total heap memory allocation 330. The mapping component 260 may record the total heap memory allocation 210A denoted at 331 that is associated with the tag 210A (321) and may record the total heap memory allocation 212A denoted at 322 that is associated with the tag 212A (322). It will be noted that ellipses 335 illustrate that there may be any number of total heap memory allocations 330 that are associated with the additional tags 325.

The total heap memory allocation may specify the total number of bytes of memory that were allocated to the system entity. For instance, if the heap memory 230 allocation that resulted from the heap memory calls 215 and 216 were 10 Mbytes, then the heap memory allocation 210A (331) would be listed as 10 Mbytes in the table 300. Likewise, if the heap memory allocation that resulted from the heap memory call 217 was 5 Mbytes, then the heap memory allocation 212A (332) would be listed as 5 Mbytes in the table 300. Accordingly, the use of the table 270 or 300 and the tags 320 allow the total heap memory allocation to be attributed to each of the system entities that have a heap memory allocation.

Returning to FIG. 2, the attribution manager 220 may receive a heap memory call 218 that requests that some or all of the heap memory allocation for a system entity be freed. For example, the heap memory call 218 may be initiated by the system entity 210 as illustrated in FIG. 2 and may request some or all of the heap memory requested by the heap memory call 215 be released or freed. Alternatively, the heap memory call 218 may be initiated by a system entity other than system entity 210, such as system entity 211 or 212, and may also request that some or all of the heap memory requested by the heap memory call 215 be released or freed. Thus, the system entity that initiates the memory call 218 to request that some or all of the heap memory requested by the heap memory call 215 be released or freed need not be the system entity 210.

Accordingly, the heap memory call 218 may include a pointer or the like (not illustrated) to the tag 210A (321) that is associated with the system entity 210. When the heap memory call 218 is passed to the heap memory allocator component 220 by the attribution manager 240, the allocation specified in the heap memory call 218 may be released or freed by the heap memory allocator component 220. The heap memory allocator component may then report the tag 210A (321) that is associated with the heap memory allocation that has been freed back to the mapping component 260 as represented by 225. The mapping component 260 may then update the table 270 or table 300. In this way, the heap memory resources attributed to the system entity 210 or to another system entity may be kept up to date as needed.

An alternative embodiment of the table 270 and the function of the mapping component 260 will now be explained. In this embodiment, the identification component 250 determines if the unique identifier is included in the table 270 and populates the table with the unique identifier as needed in the manner previously described. However, rather than mapping the specific heap memory 230 resource allocation to a tag 320, the mapping component 260 maps each system entity to a private heap allocation, which comprises an example of a specific memory resource allocation, as will now be explained.

As discussed previously, when the heap memory allocator component 220 makes a heap memory allocation in response to a heap memory call, the heap memory allocator component 220 may make the allocation from the shared heap memory 230, which is a shared memory because portions are typically allocated to multiple system entities. As a consequence, all the memory allocations attributable to a given system entity will typically not be congruent with each other in the shared heap memory 230 as the heap memory allocator component 220 determines where the allocation will be and it may make the allocation from any portion of the memory. For example, the memory allocation requested by the heap memory call 215 and the memory allocation requested by the heap memory call 216 may not be assigned in an optimum manner, even though both are attributable to the system entity 210 as previously discussed.

Accordingly, in the embodiment the mapping component 260 may map the unique identifier to a private heap pointer that causes the creation of a private heap in the heap memory 230. The attribution manager 240 may then automatically redirect all memory allocations associated with a given unique identifier to the private heap.

Turning to FIG. 4, an embodiment of a table 400, which may be an alternative embodiment of the table 270, is illustrated. As shown, the table 400 includes unique identifiers 410, which correspond to the unique identifiers 310 previously discussed. Accordingly, the table includes a unique identifier 210A denoted at 411 for the system entity 210 and a unique identifier 212A denoted at 412 for the system entity 212. The ellipses 415 illustrate that there can be any number of additional unique identifiers 410 as circumstances warrant.

The table 400 also includes heap memory pointers 420, which may correspond to a specific heap memory address in the heap memory 230 or to some other mechanism for creating a private heap in the heap memory 230. For example, the heap memory pointers 420 may denote at 421 a heap memory pointer 210A that is associated with the unique identifier 411 and denote at 422 a memory pointer 212A that is associated with the unique identifier 412. The ellipses 425 illustrate that there may be any number of additional heap memory pointers 420 as circumstances warrant

In operation, the mapping component 260 may attach the private heap memory pointer 420 to the heap memory call and then forward the heap memory call to the heap memory allocator component 220, which may then generate a private heap, which may be an example of a private portion of the shared heap memory 230. This is illustrated in FIG. 2, which shows the memory call 215 including the pointer 210A (421) and the memory call 217 including the pointer 212A (422) being passed to the heap memory allocator component 220. Although not illustrated, the heap memory call 216 including the pointer 210A (421) may also be passed to the heap memory allocator component 220. It will be noted that although the memory calls illustrated in FIG. 2 being passed to the heap memory allocator component 220 include both the tag 320 and the pointer 420, this is for ease of illustration only as in many embodiments only one of the tag or the pointer will be included in the memory calls being passed to the heap memory allocator component 220.

For example, a private memory heap 232 may be created in the heap memory 230 for the heap memory calls 215 and 216 associated with the unique identifier 411 and a private memory heap 233 may be created in the heap memory 230 for the heap memory call 217 associated with the unique identifier 412. Accordingly, the heap memory 230 resources requested by both the heap memory call 215 and the heap memory call 216, since both are attributable to the system entity 210, may be redirected to the private memory heap 232 and the heap memory resources requested by the heap memory call 217 may be redirected to the private memory heap 233.

It will be noted that from the perspective of the system entity making the heap memory call, the allocation of the heap memory resources is from the shared heap memory 230 as in the typical case previously described. In other words, the system entity making the heap memory call is unaware that the memory allocation has been automatically redirected to the private memory heap due to the mapping of the mapping component 260 previously described. This advantageously allows for all heap memory allocation attributed to a given system entity to be placed in the private memory heap such that the memory allocation is contiguous, which may increase system performance.

As another advantage, when the attribution manager 240 receives the heap memory call 218 requesting that a memory allocation be removed or freed, the attribution manger may use the table 400 to determine the heap memory pointer 420 for the allocation that to be freed. The attribution manager 240 may then provide the heap memory pointer 420 to the heap memory allocator component 220, which may simply destroy the private heap that was created in the heap memory 230 to release or free the allocation. The pointer 420 may then be removed from the table 400 so that the unique identifier is no longer associated with the pointer in the table 400.

For example, if the heap memory call 218 requested that the allocation attributed to the system entity 210 be freed, the attribution manager 240 would provide the heap memory pointer 421 to the heap memory allocator component 220, and the heap memory allocator component 220 would destroy the private heap 232. Likewise, if the heap memory call 218 requested that the allocation attributed to the system entity 212 be freed, the attribution manager 240 would provide the heap memory pointer 422 to the heap memory allocator component 220, and the heap memory allocator component 220 would destroy the private heap 233.

As mentioned previously, in some embodiments the heap memory 230 resources that may be allocated to one of the system entities 210, 211, or 212 may be associated with or subject to one or more heap memory allocation policies that specify in what manner the heap memory 230 resources are to be allocated to the system entity. That is, the memory policies specify how or when the heap memory resources are to be allocated. Accordingly, the computing system 200 may also include the policy manager component 280. Although illustrated as a separate component, in some embodiments the policy manager component 280 may be part of the attribution manager 240.

As illustrated, the policy manager component 280 may include or otherwise access one or more memory policies (herein after also referred to collectively as “memory policies 285”) 285A, 285B, and any number of additional memory policies as illustrated by the ellipses 285C. In some embodiments, the memory policies 285 may be defined by a user of the computing system 200. Use of the memory policies 285 helps to at least partially ensure that computing system 200 allocates the heap memory 230 resources to the system entities in the manner that is desirable by the user of the computing system. Specific examples of the memory policies 285 will be described in more detail to follow. It will be noted, however, that the memory policies 285 may be any reasonable memory policy and therefore the embodiments disclosed herein are not limited by the type of the memory policies 285 disclosed herein.

In operation, whenever a memory call is received by the attribution manager 240 requesting an allocation of heap memory 230 for a given system entity such as system entity 210 or system entity 212, the policy manager component 280 may review the memory policies 285 to determine if one or more of the policies are to be applied to the requested heap memory allocation. If none of the memory policies 285 are to be applied, then the policy manager component 280 informs the the attribution manager 240 to allocate the requested heap memory in the manner previously described. However, if one or more of the memory policies 285 are to be applied, then the policy manager component 280 informs the attribution manager 240 of the allocation constraint specified in the policy so that the heap memory allocation is performed in accordance with the policy. Accordingly, the policy manager component 280 ensures that the allocation of the heap memory resources is based on one or more of the memory polices 285.

In one embodiment, one or more of the memory policies 285 may specify a maximum heap memory size limit that may be allocated to a given system entity such as the system entities 210, 211, or 212. In such embodiment, upon receipt of the memory call 215, 216, or 217 the policy manager component 280 may access the table 270 to determine the current allocation of the heap memory 230 that is attributable to the given system entity. In the embodiment described in relation to table 300, the policy manager component 280 may access the total heap memory allocations 230 to determine the current heap memory allocation, for example total heap memory allocation 210A (331) or total heap memory allocation 212A (332). As described previously, the total heap memory allocations 230 list the size of the current heap memory allocation attributed to the system entity.

In the embodiment described in relation to table 400, the policy manager component 280 may access the heap memory pointers 420, for example heap memory pointer 210A (421) and heap memory pointer 212A (422). The policy manager component 280 may then use the memory pointers 420 to query the heap memory allocator component 220 for the current size of the private memory heap 232 or 233.

Once the policy manager component 280 has determined the current allocation of the heap memory attributed to the system entity 210 or 212, the policy manager 280 may determine if the heap memory allocation requested in the memory call 215, 216, or 217 complies with the limitation specified in the policy by ensuring that the requested heap memory allocation does not exceed the maximum heap memory limit. If the heap memory allocation requested in the memory call does comply with the limitation specified in the policy, the policy manager component may direct the attribution manager 240 to provide the allocation in the manner previously described. If, however, the heap memory allocation requested in the memory call fails to comply with the limitation specified in the policy, then the memory manager component 280 may direct the attribution manager 240 to fail the heap memory allocation.

For example, suppose that the policy 385A specified that the system entity 210 was only entitled to be allocated 10 Mbytes of heap memory 230, either from the shared resources or from a private heap. Further suppose that the policy manager component 280 determined from the table 270, either from the embodiment of table 300 or the embodiment of table 400, that the current allocation attributable to system entity 210 was 5 Mbytes. If one or both of the memory calls 215 and 216 requested an allocation of 4 Mbytes of heap memory, this would comply with the memory policy 285A as the additional allocation of 4 Mbytes would not be more than the 10 Mbyte limit. Accordingly, the policy manager component 280 would direct the attribution manager 240 to allow the memory allocation to proceed.

On the other hand, if one or both of the memory calls 215 and 216 requested an allocation of 10 Mbytes of heap memory, this would not comply with the memory policy 285A as the additional allocation of 10 Mbytes would be more than 10 Mbyte limit. Accordingly, the policy manager component 280 would direct the attribution manager 240 to fail the memory allocation.

In another embodiment, one or more of the memory policies 285 may specify or guarantee a quality of service level for the heap memory allocations to each of the system entities. For example, suppose the memory policy 285B ensured that the system entity 210 would have a high level of memory allocation service and that system entity 212 would have a lower level of memory allocation service. Further suppose that when the memory calls 215 and 217 are received, the heap memory 230 was having high usage so that the memory allocation was slowed. Accordingly, the policy manager component 280 could apply the memory policy 285B, which would result in the policy manager component directing the attribution manager 240 to allow the allocation request for the system entity 210 to proceed while delaying the allocation request for the system entity 212 until such time as the usage of the heap memory 230 was lower. Since the system entity 210 had the higher quality of service guarantee, it was given the higher level of service.

In another embodiment, one or more of the memory policies 285 may specify that the system entity 210 be allocated high priority memory, which may be a portion of the heap memory 230 where the page requests of the system entity 210 are likely to stay in the heap memory and not be allocated to a secondary memory such as the hard drive. Likewise, the memory policy may specify that the system entity 212 be allocated low priority memory, which may be a portion of the heap memory 230 where page requests are likely to allocated to the secondary memory. Accordingly, when the memory calls 215, 216, and 217 are received, the policy manager component 280 may apply the policy and direct the attribution manager 240 to allocate the high priory portion to system entity 210 and the low priority portion to system entity 212.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

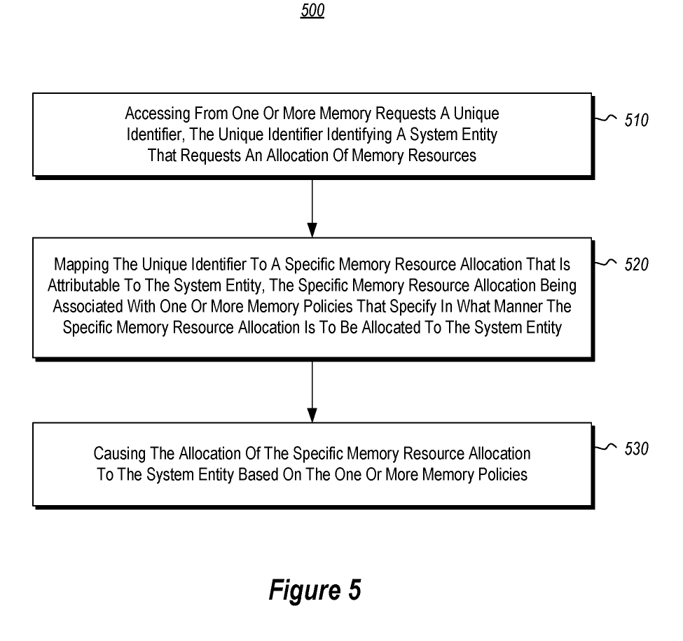

FIG. 5 illustrates a flow chart of an example method 500 for attribution of memory resources allocated to a system entity. The method 500 will be described with respect to FIGS. 2-4 discussed previously.

The method 500 includes an act of accessing from one or more memory requests a unique identifier (act 510). The unique identifier may identify a system entity that requests an allocation of memory resources. For example as previously discussed the identification component 250 may access a unique identifier 210A from the memory calls 215 and 216 and a unique identifier 212A from the memory call 217. The unique identifiers may identify the system entities 210 and 212 that initiated the requests for an allocation of the heap memory 230. In some embodiments, the identification component 250 may access the table 270, 300, or 400 to determine if the unique identifier is located in the list 310 or 410 and may populate the list with the unique identifier if it is not included in the list.

The method 500 includes an act of mapping the unique identifier to a specific memory resource allocation that is attributable to the system entity (act 520). The specific memory resource allocation is associated with one or more memory policies that specify in what manner the specific memory resource allocation is to be allocated to the system entity.

For example, as previously described the mapping component 260 may map the unique identifiers 210A and 212A to a specific memory resource allocation of the heap memory 230. In one embodiment, the mapping component 260 performs this mapping using the tags 320 in the manner previously discussed to map to the total heap memory allocations 230, 231, and 232, which are examples of the specific memory resource allocation. In another embodiment the mapping component 260 performs the mapping by generating the private heaps 232 and 233, which are examples of the specific memory resource allocation, by using the memory pointers 420 as previously described.

As previously described, the specific resource allocation for the system entities 210 or 212 are associated with one or more of the memory rules 285. The policies may specify in what manner the specific memory resource allocation is to be allocated to the system entity as previously described.

The method 500 includes an act of causing the allocation of the specific memory resource allocation to the system entity based on the one or more memory policies (act 530). For example, as previously described, the policy manager component 280 may ensure that specific memory resource allocation is only allocated to the system entities 210 and 212 when the policies 285 are complied with.

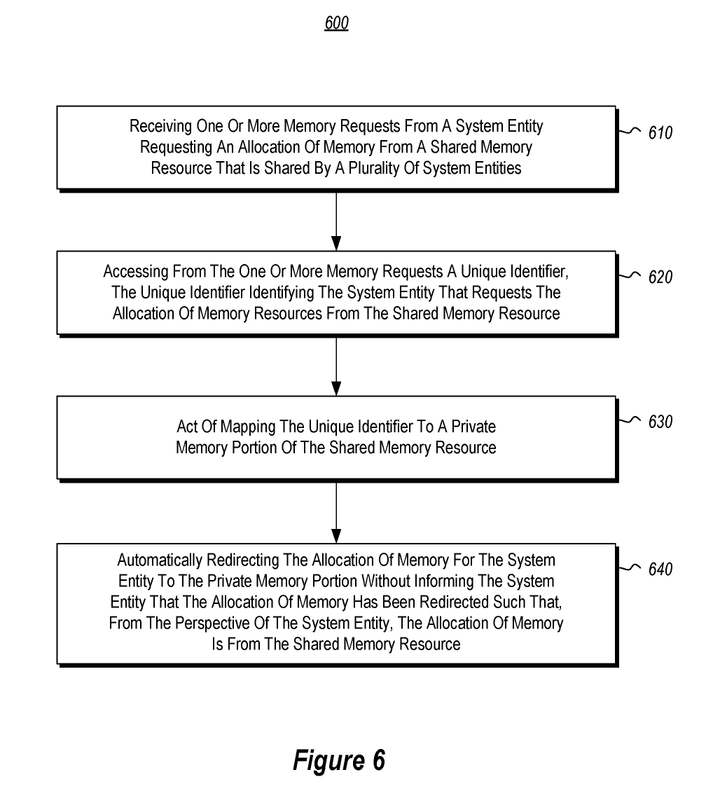

FIG. 6 illustrates a flow chart of an example method 600 for attribution of memory resources allocated to a system entity. The method 600 will be described with respect to FIGS. 2-4 discussed previously.

The method 600 includes an act of receiving one or more memory requests from a system entity requesting an allocation of memory from a shared memory resource that is shared by a plurality of system entities (act 610). For example as previously discussed attribution manager 220 may receive a memory call 215 and/or 216 from the system entity 210 and a memory call 217 from the system entity 212. The memory calls may request an allocation of the heap memory 230 for their initiating system entities. As previously discussed, the heap memory 230 is considered a shared memory resource since it may be allocated to multiple system entities.

The method 600 includes an act of accessing from the one or more memory requests a unique identifier (act 620). The unique identifier may identify a system entity that requests an allocation of memory resources. For example as previously discussed the identification component 250 may access a unique identifier 210A from the memory calls 215 and 216 and a unique identifier 212A from the memory call 217. The unique identifiers may identify the system entities 210 and 212 that initiated the requests for an allocation of the heap memory 230. In some embodiments, the identification component 250 may access the table 270, 300, or 400 to determine if the unique identifier is located in the list 410 and may populate the list with the unique identifier if it is not included in the list.

The method 600 includes an act of mapping the unique identifier to a private memory portion of the shared memory resource (act 630). For example, as previously described mapping component 260 performs the mapping by generating the private heaps 232 and 233 by using the memory pointers 420 as previously described.

The method 600 includes an act of automatically redirecting the allocation of memory for the system entity to the private memory portion without informing the system entity that the allocation of memory has been redirected such that, from the perspective of the system entity, the allocation of memory is from the shared memory resource (act 640). As previously described, all memory allocations for the system entity 210 are automatically redirected to the private heap 232 and all memory allocations for the system entity 212 are automatically redirected to the private heap 233. The automatic redirect includes future memory allocations. As further mentioned, this redirect is unknown to the system entity, which still perceives that the memory allocation is from the shared heap memory 230.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computing system for attribution of memory resources allocated to a system entity running on the computing system comprising:
one or more processors;
system memory having stored thereon computer executable instructions that when executed, cause the computing system to perform the following:
an act of accessing from one or more memory requests a unique identifier, the unique identifier identifying a system entity that requests an allocation of memory resources;
an act of mapping the unique identifier to a specific memory resource allocation that is attributable to the system entity, the specific memory resource allocation being associated with one or more memory policies that specify in what manner the specific memory resource allocation is to be allocated to the system entity; and
an act of causing the allocation of the specific memory resource allocation to the system entity based on the one or more memory policies.

2. The computing system in accordance with claim 1, wherein the act of accessing from the one or more memory requests the unique identifier comprises:
an act of accessing a table having stored thereon a list of unique identifiers for a plurality of system entities that have previously requested a memory allocation;
an act of determining if the unique identifier for the system entity is included in the list of unique identifiers, the inclusion of the unique identifier for the system entity indicating that the system entity has made a previous request for a memory allocation;

3. The computing system in accordance with claim 2, further comprising:
an act of populating the unique identifier for the system entity in the list of unique identifiers when it is determined that the unique identifier for the system entity is not included in the list.

4. The computing system in accordance with claim 1, wherein the act of mapping the unique identifier to a specific memory resource allocation comprises:
an act of attaching a tag to the unique identifier, the tag allowing for all memory allocations associated with the tag to be attributable to the system entity;
an act of populating a table with the tag;
an act of providing the tag along with the request for the specific memory resource allocation to a memory allocation component that performs the allocation; and
an act of recording in the table the specific memory resource allocation.

5. The computing system of claim 4, further comprising:
an act of receiving a request to free the specific memory resource allocation;
an act of freeing the specific memory resource allocation in accordance with the request; and
an act of using the tag to update the memory allocation attributable to the system entity in the table.

6. The computing system in accordance with claim 1, wherein the act of mapping the unique identifier to a specific memory resource allocation comprises:
an act of associating in a table the unique identifier with a pointer to a private memory portion of a shared memory resource; and
an act of automatically redirecting the allocation of memory for the system entity to the private memory portion without informing the system entity that the allocation of memory has been redirected such that, from the perspective of the system entity, the allocation of memory is from the shared memory resource.

7. The computing system in accordance with claim 6, wherein the pointer is an address for the private memory portion.

8. The computing system in accordance with claim 6, further comprising:
an act of receiving a request to free the specific memory resource allocation;
an act of freeing the specific memory resource allocation by destroying the private memory portion in the in the shared memory resource; and
an act of removing the pointer from the table.

9. The computing system in accordance with claim 1, wherein the one or more memory policies specify a maximum size for the specific memory allocation.

10. The computing system in accordance with claim 10, wherein when the specific memory resource allocation exceeds the maximum size, the computing system fails the specific memory resource allocation.

11. The computing system in accordance with claim 1, wherein the one or more memory policies specify a priority for which the system entity is to be allocated the specific memory resource allocation.

12. The computing system in accordance with claim 1, further comprising:
an act of failing the allocation of the specific memory resource allocation to the system entity when the one or more memory policies are not satisfied.

13. A computing system for attribution of memory resources allocated to a system entity running on the computing system comprising:
one or more processors;
system memory having stored thereon computer executable instructions that when executed, cause the computing system to perform the following:
an act of receiving one or more memory requests from a system entity requesting an allocation of memory from a shared memory resource that is shared by a plurality of system entities;
an act of accessing from the one or more memory requests a unique identifier, the unique identifier identifying the system entity that requests the allocation of memory resources from the shared memory resource;
an act of mapping the unique identifier to a private memory portion of the shared memory resource; and
an act of automatically redirecting the allocation of memory for the system entity to the private memory portion without informing the system entity that the allocation of memory has been redirected such that, from the perspective of the system entity, the allocation of memory is from the shared memory resource.

14. The computing system in accordance with claim 13, further comprising:
an act of applying one or more memory policies to the allocation of the private memory portion.

15. The computing system in accordance with claim 14, wherein the computing system fails the allocation of the private memory portion when the one or more memory policies are not complied with.

16. The computing system in accordance with claim 13, the act of mapping the unique identifier to the private memory portion of the shared memory resource comprises:
an act of associating in a table the unique identifier with a pointer to the private memory portion of the shared memory resource

17. A method for attribution of memory resources allocated to a system entity, the method comprising:
an act of accessing from one or more memory requests a unique identifier, the unique identifier identifying a system entity that requests an allocation of memory resources;
an act of mapping the unique identifier to a specific memory resource allocation that is attributable to the system entity, the specific memory resource allocation being associated with one or more memory policies that specify in what manner the specific memory resource allocation is to be allocated to the system entity; and
an act of causing the allocation of the specific memory resource allocation to the system entity based on the one or more memory policies.

18. The method in accordance with claim 17, wherein the act of accessing from the one or more memory requests the unique identifier comprises:
an act of accessing a table having stored thereon a list of unique identifiers for a plurality of system entities that have previously requested a memory allocation;
an act of determining if the unique identifier for the system entity is included in the list of unique identifiers, the inclusion of the unique identifier for the system entity indicating that the system entity has made a previous request for a memory allocation; and
an act of populating the unique identifier for the system entity in the list of unique identifiers when it is determined that the unique identifier for the system entity is not included in the list.

19. The method in accordance with claim 17, wherein the act of mapping the unique identifier to a specific memory resource allocation comprises:
an act of attaching a tag to the unique identifier, the tag allowing for all memory allocations associated with the tag to be attributable to the system entity;
an act of populating a table with the tag;
an act of providing the tag along with the request for the specific memory resource allocation to a memory allocation component that performs the allocation; and
an act of recording in the table the specific memory resource allocation.

20. The method in accordance with claim 17, wherein the act of mapping the unique identifier to a specific memory resource allocation comprises:
an act of associating in a table the unique identifier with a pointer to a private memory portion of a shared memory resource; and
an act of automatically redirecting the allocation of memory for the system entity to the private memory portion without informing the system entity that the allocation of memory has been redirected such that, from the perspective of the system entity, the allocation of memory is from the shared memory resource.
